(19) United States
(12) Patent Application Publication
(10) Pub. No.: US 2015/0295691 A1
(43) Pub. Date: Oct. 15, 2015

(54) METHODS AND APPARATUS FOR SENDING AN UPLINK RE-TRANSMISSION AFTER A TUNE AWAY PERIOD

(71) Applicant: QUALCOMM Incorporated, San Diego, CA (US)

(72) Inventors: Hamidreza KHAZAEI, San Diego, CA (US); Reza SHAHIDI, San Diego, CA (US); Deepak KRISHNAMOORTHI, San Diego, CA (US); Chintan Shirish SHAH, San Diego, CA (US)

(21) Appl. No.: 14/679,729

(22) Filed: Apr. 6, 2015

Related U.S. Application Data
(60) Provisional application No. 61/978,670, filed on Apr. 11, 2014.

(51) Int. Cl. H04L 5/00; H04W 72/12

(52) U.S. Cl. CPC H04L 5/0055; H04W 72/1263

(57) ABSTRACT

Certain aspects of the present disclosure relate to methods and apparatus for a user equipment (UE) to transmit an uplink signal, even though the UE may not have received a negative acknowledgement (NACK) corresponding to the uplink signal from a network due to a tune away period. The method may generally include determining that an acknowledgement/negative acknowledgement (ACK/NACK) signal from a first network corresponding to an uplink signal is scheduled within a tune away period to a second network, and transmitting at least a portion of the uplink signal upon completion of the tune away period based on the determination.

### CLAIM OF PRIORITY UNDER 35 U.S.C. §119

The present application claims priority to provisional U.S. Application Ser. No. 61/978,670, entitled “METHODS AND APPARATUS FOR SENDING AN UPLINK RE-TRANSMISSION AFTER A TUNE AWAY PERIOD,” filed Apr. 11, 2014, which is assigned to the assignee of the present application and hereby expressly incorporated by reference herein in its entirety.

### FIELD

The present disclosure relates generally to wireless communication, and more particularly, to methods and apparatus for accelerating retransmission of an uplink channel, such as a physical uplink shared channel (PUSCH).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Certain aspects of the present disclosure relate to a method for wireless communication. The method generally includes determining that at least a portion of an acknowledgement/negative acknowledgement (ACK/NACK) signal from a first network corresponding to an uplink signal is scheduled within a tune away period to a second network. The method may further include transmitting at least a portion of the uplink signal upon completion of the tune away period based on the determination.

Certain aspects of the present disclosure relate to an apparatus for wireless communication. The apparatus generally includes a processor configured to determine that at least a portion of an ACK/NACK signal from a first network corresponding to an uplink signal is scheduled within a tune away period to a second network. The apparatus generally may further include a transmitter configured to transmit, via at least one antenna, at least a portion of the uplink signal upon completion of the tune away period based on the determination.

Certain aspects of the present disclosure generally include an apparatus for wireless communication, comprising means for determining that at least a portion of an ACK/NACK signal from a first network corresponding to an uplink signal is scheduled within a tune away period to a second network. The apparatus may further include means for transmitting at least a portion of the uplink signal upon completion of the tune away period based on the determination.

Certain aspects of the present disclosure generally include a computer-readable storage device comprising instructions executable to determine that at least a portion of an ACK/NACK signal from a first network corresponding to an uplink signal are scheduled within a tune away period to a second network. The computer-readable storage device may further include instructions executable to transmit at least a portion of the uplink signal upon completion of the tune away period based on the determination.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network, in accordance with certain aspects of the disclosure.

FIG. 7 illustrates an example timing diagram for transmitting (or retransmitting) an uplink signal after a tune away period, in accordance with certain aspects of the present disclosure.

FIG. 8 illustrates example operations performed, for example, by a UE for sending an uplink signal after a tune away period, in accordance with certain aspects of the present disclosure.

### DETAILED DESCRIPTION

Aspects of the present disclosure provide techniques that may improve performance by accelerating the transmission (or retransmission) of an uplink transmission by a device in a first network, in the event a corresponding downlink ACK/NACK transmission acknowledging (or negatively acknowledging) the uplink transmission is scheduled to occur while the device has tuned away from the first network. For example, in response to detecting the ACK/NACK transmission is to occur during a tune away period, the device may automatically transmit (or re-transmit) the uplink transmission after the tune away period (despite not having received a NACK). This may improve performance, as the device might otherwise pause sending data for a hybrid automatic repeat request (HARQ) process if the ACK/NAK is not received.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software/firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

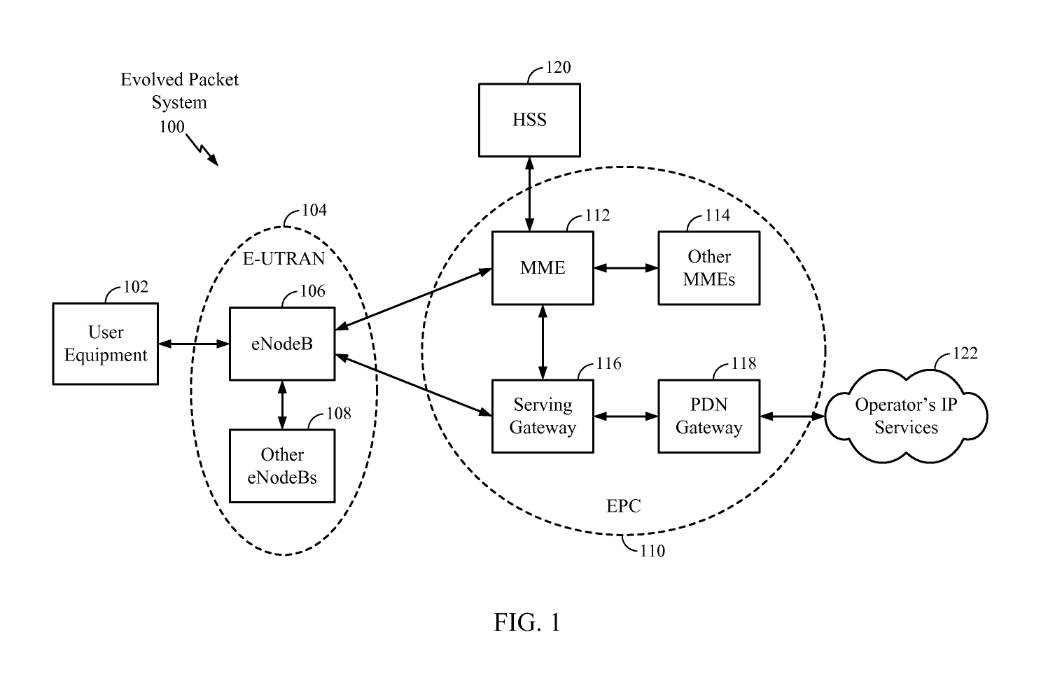

FIG. 1 is a diagram illustrating an example architecture 100, in which aspects of the present disclosure may be practiced. For example, a UE 102 may be configured to automatically transmit (or re-transmit) an uplink transmission after a tune away period, in response to detecting a corresponding ACK/NACK transmission is to occur during the tune away period.

According to certain aspects, the architecture 100 of FIG. 1 may be an LTE network architecture. “LTE” refers generally to LTE, LTE-Advanced (LTE-A), LTE in an unlicensed spectrum (LTE-whitespace), etc. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), an access point, or some other suitable terminology. The eNB 106 may provide an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, an ultrabook, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS (packet-switched) Streaming Service (PSS). In this manner, the UE102 may be coupled to the PDN through the LTE network.

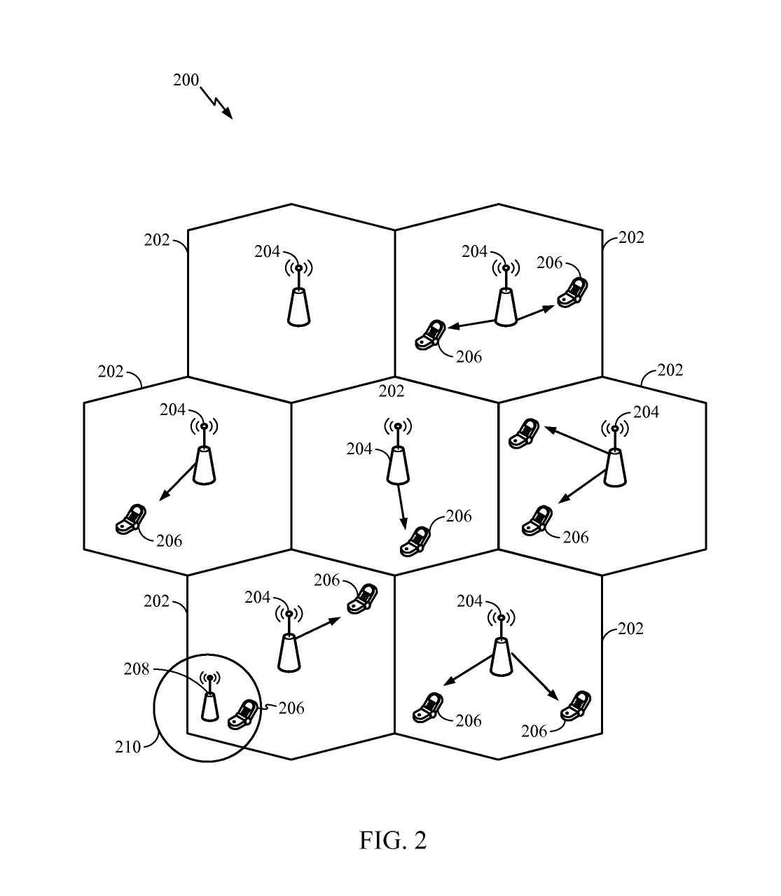

FIG. 2 is a diagram illustrating an example of an access network 200 (e.g., an LTE network architecture), in which aspects of the present disclosure may be practiced. For example, UEs 206 may be configured to perform operations described herein.

In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. The network 200 may also include one or more relays (not shown). According to one application, a UE may serve as a relay.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

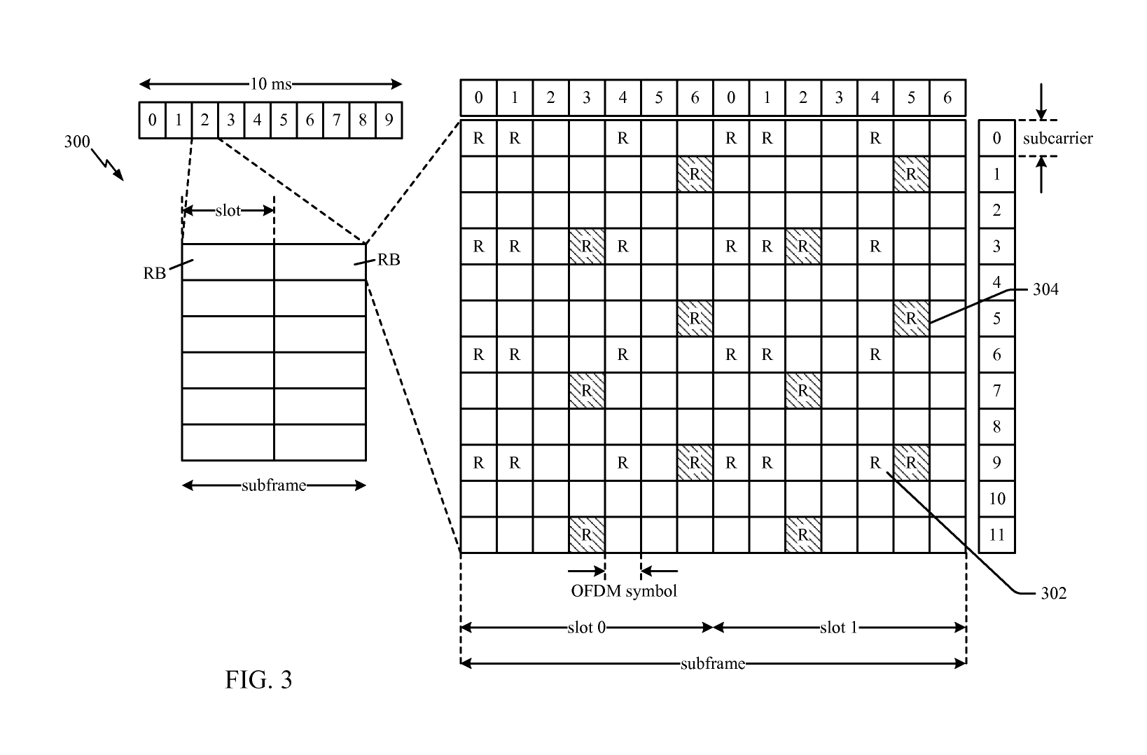

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, R 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH. In aspects of the present methods and apparatus, a subframe may include more than one PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

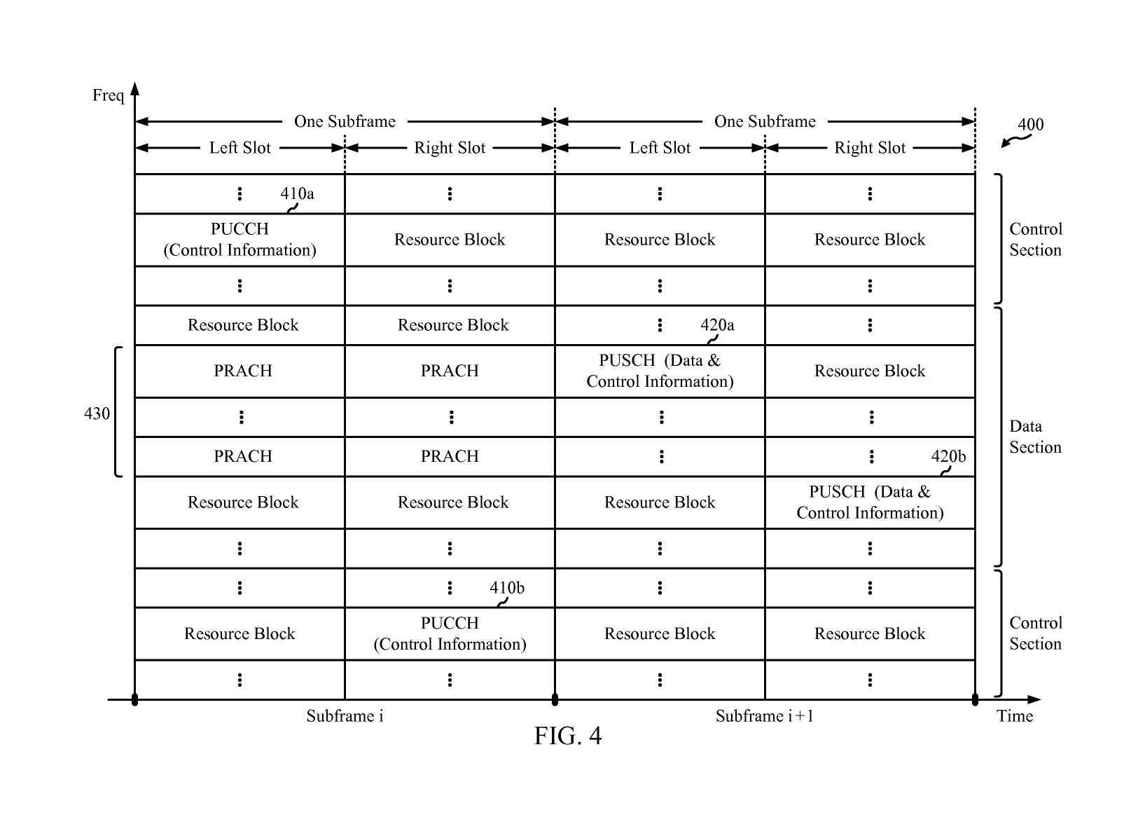

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

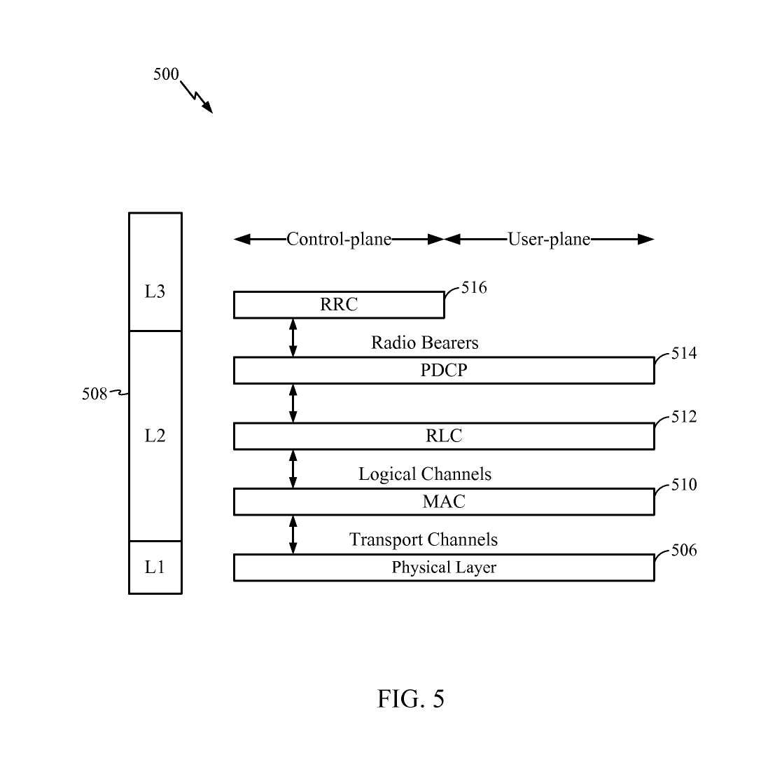

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

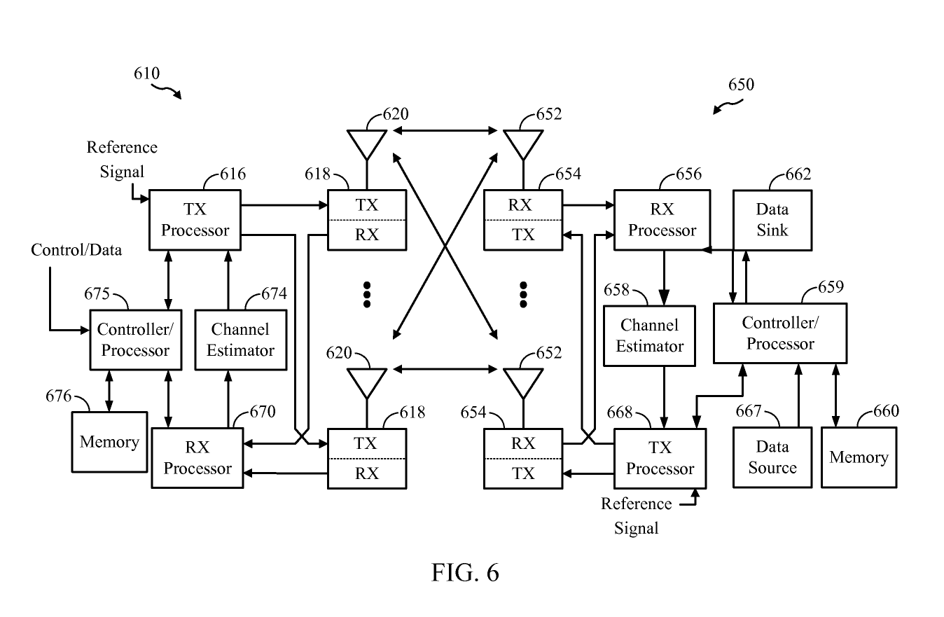

FIG. 6 is a block diagram of an eNB 610 in communication with a UE 650 in an access network. According to certain aspects, UE 650 may be configured to perform operations described herein.

In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations. The controllers/processors 675, 659 may direct the operation at the eNB 610 and the UE 650, respectively.

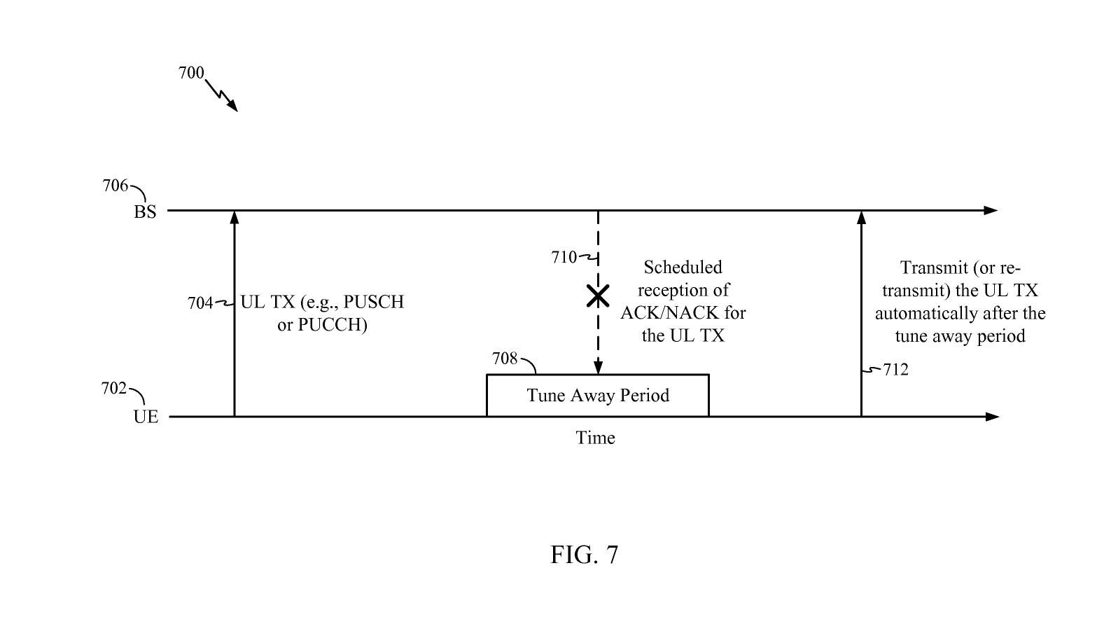

The controller/processor 659 and/or other processors and modules at the UE 650 may perform or direct operations for example operations 700 in FIG. 7, and/or other processes for the techniques described herein. For example, controller/processor 659 may be configured to determine that at least a portion of an ACK/NACK signal from a first network, corresponding to a previously transmitted uplink signal, may be scheduled within a tune away period to a second network. In such an aspect, controller/processor 659, TX processor 668, and/or transmitter 654 may be configured cause the UE 650 to automatically transmit (or re-transmit) an uplink transmission after a tune away period, in response to detecting a corresponding ACK/NACK transmission is to occur during the tune away period.

In certain aspects of the present disclosure, a UE (e.g., UE 650, UE 102, UE 206, etc.) may be configured with dual Subscriber Identity Module (SIM) capabilities. That is, the UE may include two SIM adapters to hold two SIM cards. Dual SIM operation allows use of two services (or networks) operating on different channels by a single UE. In another aspect, Dual SIM operation may allow for use of two or more radio access technologies (RATs) where access to each RAT may be based on a different SIM card. For example, a UE may be configured to operate in a LTE and GSM Dual SIM Dual Standby (DSDS).

DSDS configured UEs allow both SIM cards to be on standby waiting for a call/data connection. When a call/data is established on one SIM card, the other is no longer active. In a Dual SIM configuration, both the SIMs time share one or more of antenna(s), such that only one SIM may use the one or more of antenna(s) at one time. In certain aspects, while a UE having Dual SIM configuration has an active call on one channel (associated to one of the SIMs), the UE periodically tunes away from this active channel to monitor another channel (associated to the other SIM) to check for calls or data.

In certain aspects, where a UE is configured in LTE and GSM DSDS mode and is actively connected to the LTE network, the UE may generate an artificial gap during LTE communications (e.g., a tune away period) to allow the GSM based SIM to decode pages communicated by the GSM network. Therefore, since the UE has tuned away from LTE, the UE may not perform LTE related communications (e.g., any LTE communication on, for example, PUCCH, PUSCH, or PHICH) with the network. In an aspect, after the tune away period is over and the UE returns to the LTE network, the LTE network may expect the UE to transmit (or re-transmit) any uplink communication that was expected during the tune away period. However, if the UE was unable to decode LTE networks ACK/NACK transmissions (via the PHICH) that coincided within the tune away period, the UE may not transmit the packet(s) that a network may have indicated as being NACKed.

Aspects of the present disclosure, however, may allow a UE to automatically transmit (or re-transmit) the uplink transmission after the tune away period, in response to detecting the ACK/NACK transmission is to occur during a tune away period.

In other words, in certain aspects of the present disclosure, a UE may be configured to determine that at least a portion of an ACK/NACK response from a network, corresponding to an uplink signal from the UE, is scheduled to fall within a tune away period. Based on this determination, the UE may assume that the network NACKed the uplink signal and automatically transmit (or retransmit) the uplink signal once the tune away period is complete. In an aspect, the uplink signal may be a data signal which may be transmitted on a PUSCH or a control signal that may be transmitted on a PUCCH. In certain aspects, the ACK/NACK response may be communicated using a PHICH.

FIG. 7 illustrates a timing diagram 700 for sending uplink communications after a tune away period, in accordance with certain aspects of the present disclosure. In the illustrated example, a UE 702 transmits an uplink signal 704, intended for a base station 706 (e.g., a PUSCH or PUCCH) prior to a tune away period 708. As noted above, a portion of the uplink signal 704 may be scheduled within the tune away period 708.

In any case, the UE may determine that an ACK/NACK 710 for the uplink transmission is scheduled to be transmitted by the base station 706 during the tune away period 708. In response, the UE 702 may automatically transmit the uplink signal 712 after the tune away period 708.

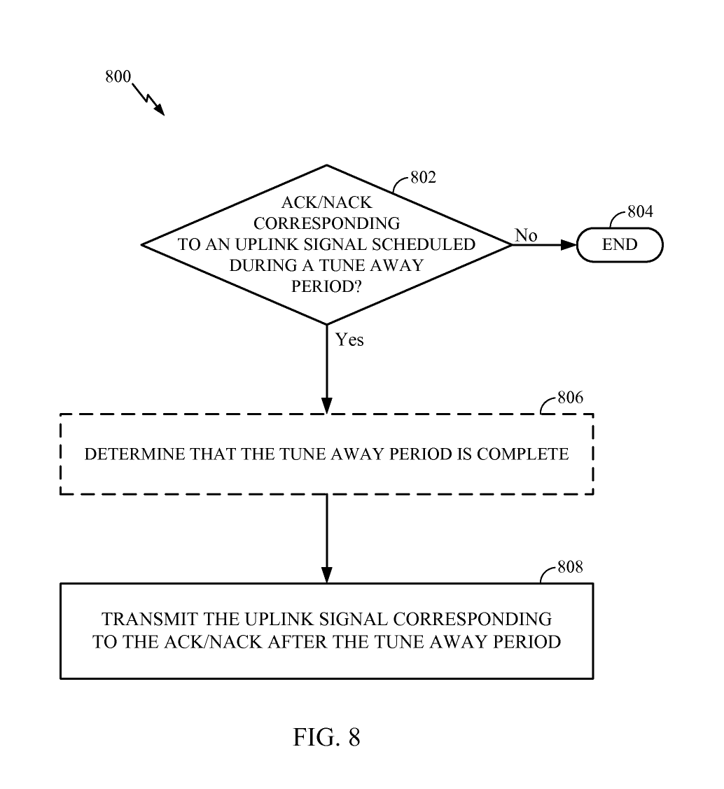

FIG. 8 illustrates example operations 800 performed, for example, by a UE (e.g., UE 650, UE 102, UE 206, etc.), in accordance with certain aspects of the present disclosure.

Operations 800 begin, at 802, by determining whether at least a portion of an ACK/NACK from a first network corresponding to an uplink signal are scheduled within a tune away period. In an aspect, the ACK/NACK response may be communicated using a PHICH, which the UE may be unable to decode during the tune away period. In an aspect, UE 650 includes at least memory 660 and controller/processor 659. Further, controller/processor 659 may provide means for determining whether at least a portion of an ACK/NACK signal from a first network, corresponding to an uplink signal, is schedule within a tune away period to a second network. If the UE determines that there was no ACK/NACK response expected (e.g., scheduled) during the tune away period, then the operation 800 may end at 804.

By contrast, if at 802, the UE determines that at least a portion of the ACK/NACK response from the network, corresponding to the uplink signal, was scheduled during the tune away period, then the UE may assume that the network NACKed the uplink signal and transmit the uplink signal after the tune away period and proceed to 706.

At 806, the UE may determine that the tune away period is complete. Further, controller/processor 659 may provide means for this determination. At 808, the UE may assume an ACK/NACK response was missed during the tune away period and (automatically) transmit/retransmit the uplink signal corresponding to the ACK/NACK after the tune away period. In an aspect, TX processor 668 and/or transmitter 654 may provide means for the transmission/retransmission.

In certain aspects, the determination (e.g., at 802 of operation 800) may further comprise determining that at least a portion of the uplink signal was also scheduled within the tune away period (such that the portion may not be sent). In an aspect, to prompt the UE to transmit the uplink data, the UE may internally generate an artificial NACK response corresponding to the uplink signal that was scheduled for transmission, by an eNB, during the tune away. Further, controller/processor 659 may provide means for internally generating an artificial NACK response corresponding to the uplink signal that was scheduled during the tune away.

In certain aspects, the first network may be an LTE network, or a single radio LTE (SRLTE) network. In certain aspects, the second network to which the UE tunes away may be a GSM network, a 1× network, Wideband Code Division Multiple Access (WCDMA) network, or Time Division Synchronous Code Division Multiple Access (TD-SCDMA) network. In still another aspect, the first network may be any network that supports predictably scheduled communications and ACK/NACKs, and the second network to which the UE tunes away may be any network the UE is configured to support based on the second SIM.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

Moreover, the term “or” is intended to mean an inclusive “or” rather than an exclusive “or.” That is, unless specified otherwise, or clear from the context, the phrase, for example, “X employs A or B” is intended to mean any of the natural inclusive permutations. That is, for example the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. A phrase referring to “at least one of” a list of items refers to any combination of those items, including single members. As an example, “at least one of: a, b, or c” is intended to cover: a, b, c, a-b, a-c, b-c, and a-b-c.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for wireless communication, comprising:
determining that at least a portion of an acknowledgement/negative acknowledgement (ACK/NACK) signal from a first network corresponding to an uplink signal is scheduled within a tune away period to a second network; and
transmitting at least a portion of the uplink signal upon completion of the tune away period based on the determination.

2. The method of claim 1, further comprising determining that the tune away period is complete.

3. The method of claim 1, further comprising generating an artificial NACK response corresponding to the uplink signal.

4. The method of claim 1, wherein the uplink signal comprises a data signal transmitted over a physical uplink shared channel (PUSCH).

5. The method of claim 1, wherein the ACK/NACK signal is to be received over a Physical Hybrid-ARQ Indicator Channel (PHICH).

6. The method of claim 1, wherein the first network comprises a long term evolution (LTE) network or a single radio LTE (SRLTE) network.

7. The method of claim 1, wherein the second network comprises a Global System for Mobile Communications (GSM) network or a 1× network.

8. The method of claim 1, wherein the determining comprises determining that the portion of the uplink signal is scheduled within the tune away period.

9. An apparatus for wireless communication, comprising:
a processor configured to:
determine that at least a portion of an acknowledgement/negative acknowledgement (ACK/NACK) signal from a first network corresponding to an uplink signal is scheduled within a tune away period to a second network; and
transmit, via at least one antenna, at least a portion of the uplink signal upon completion of the tune away period based on the determination.

10. The apparatus of claim 9, wherein the processor is further configured to determine that the tune away period is complete.

11. The apparatus of claim 9, wherein the determining further comprises generating an artificial NACK response corresponding to the at least a portion of the uplink signal.

12. The apparatus of claim 9, wherein the uplink signal comprises a data signal transmitted over a physical uplink shared channel (PUSCH).

13. The apparatus of claim 9, wherein the ACK/NACK signal is to be received over a Physical Hybrid-ARQ Indicator Channel (PHICH).

14. The apparatus of claim 9, wherein the first network comprises a long term evolution (LTE) network or a single radio LTE (SRLTE) network.

15. The apparatus of claim 9, wherein the second network comprises a Global System for Mobile Communications (GSM) network or a 1× network.

16. The apparatus of claim 9, wherein the determining comprises determining that the portion of the uplink signal is scheduled within the tune away period.

17. An apparatus for wireless communication, comprising:
means for determining that at least a portion of an acknowledgement/negative acknowledgement (ACK/NACK) signal from a first network corresponding to an uplink signal is scheduled within a tune away period to a second network; and
means for transmitting at least a portion of the uplink signal upon completion of the tune away period based on the determination.

18. The apparatus of claim 17, wherein the means for determining is further configured to determine that the tune away period is complete.

19. The apparatus of claim 17, further comprising means for generating an artificial NACK response corresponding to the at least a portion of the uplink signal.

20. The apparatus of claim 17, wherein the uplink signal comprises a data signal transmitted over a physical uplink shared channel (PUSCH).

21. The apparatus of claim 17, wherein the ACK/NACK signal is to be received over a Physical Hybrid-ARQ Indicator Channel (PHICH).

22. The apparatus of claim 17, wherein the first network comprises a long term evolution (LTE) network or a single radio LTE (SRLTE) network.

23. The apparatus of claim 17, wherein the second network is a Global System for Mobile Communications (GSM) network or a 1× network.

24. The apparatus of claim 17, wherein the means for determining is further configured to determine that the portion of the uplink signal is scheduled within the tune away period.

25. A computer-readable storage device comprising instructions executable to:
determine that at least a portion of an acknowledgement/negative acknowledgement (ACK/NACK) signal from a first network corresponding to an uplink signal are scheduled within a tune away period to a second network; and
transmit, via at least one antenna, at least a portion of the uplink signal upon completion of the tune away period based on the determination.

26. The computer-readable storage device of claim 25, wherein the instructions are further executable to determine that the tune away period is complete.

27. The computer-readable storage device of claim 25, wherein the instructions are further executable to generate an artificial NACK response corresponding to the at least a portion of the uplink signal.

28. The computer-readable storage device of claim 25, wherein the uplink signal comprises a data signal transmitted over a physical uplink shared channel (PUSCH).

29. The computer-readable storage device of claim 25, wherein the first network comprises a long term evolution (LTE) network or a single radio LTE (SRLTE) network, and wherein the second network is a Global System for Mobile Communications (GSM) network or a 1× network.

30. The computer-readable storage device of claim 25, wherein the instructions are further executable to determine that the portion of the uplink signal is scheduled within the tune away period.
